(19) United States
(12) Patent Application Publication
(10) Pub. No.: US 2005/0161119 A1
(43) Pub. Date: Jul. 28, 2005

(54) Directionally oriented particle composites

(76) Inventors: Geoffrey P McKinght, Santa Monica, CA (US); Gregory P. Carmen, Los Angeles, CA (US)

Correspondence Address: DAVID J. OLDENKAMP, ESQ., SHAPIRO & DUPONT LLP, 233 WILSHIRE BOULEVARD, SUITE 700, SANTA MONICA, CA, 90401, US

(21) Appl. No.: 10/504,308

(22) PCT Filed: Feb. 21, 2003
(86) PCT No.: PCT/US03/05130

Related U.S. Application Data
(60) Provisional application No. 60/360,470, filed on Feb. 28, 2002.

(51) Int. Cl. H01F 1/20

(52) U.S. Cl. 148/108

(57) ABSTRACT

Magnetostrictive particulate composites with a preferred crystal orientation of the particles and methods for their manufacture are described. In a representative embodiment, a 25% volume Terfenol-D fraction polymer matrix composite was fabricated in a magnetic field using geometric anisotropy to orient needle shaped particles with long axis [112] orientation along the length of the composite. Results demonstrate that the magnetostriction of a [112] oriented particle composite saturates near 1600 ppm. This is a significant increase when compared to composites without preferential orientation (1200 ppm) and represents the largest reported magnetostriction for a particulate composite material.

### RELATED APPLICATIONS

This application claims priority under Section 119(e) from U.S. Provisional Application Ser. No. 60/360,470 filed Feb. 28, 2002, the contents of which are incorporated herein by reference.

### STATEMENT OF GOVERNMENT SUPPORT

Portions of this work have been performed under the auspices of the National Science Foundation Grant No. CMS-9815208. The government may have certain rights to this invention.

### FIELD OF THE INVENTION

The invention is in the area of particulate-based composite materials and methods for generating and using such materials. More specifically, the invention relates to magnetostrictive powder composites and methods for making such composites.

### BACKGROUND OF THE INVENTION

Magnetostrictive composites typically comprise rare earth metals (RE) and transition metals (e.g. Fe, Ni, Co and Mn), (RE)ₓFe₁₋ₓ, and exhibit a significant ability to change their length when exposed to an external magnetic field. In contrast to traditional magnetostrictive materials such as Fe and Ni which display magnetostrictive change in length of 9 μm/m and 40 μm/m respectively, a magnetostrictive powder composite typically displays length changes of more than 1000 μm/m and is therefore called a giant magnetostrictive material. Because of this, magnetostrictive powder composites are typically used to generate large and fast movements of high precision and large force. In most applications this large force is used to increase change in length and to generate larger movements.

Magnetostrictive powder composites are typically used in high frequency applications (up to 60 kHz), e.g. for ultrasonic applications. In such applications the purpose of the magnetostrictive composite is to work as an acoustic projector i.e. to generate fast mechanical movements and ultrasound. In addition, magnetic powder composites have been proposed as a means to increase the bandwidth of the casted giant magnetostrictive material available on the market. For example, magnetostrictive powder composites can manage a frequency region of 0-60 kHz, while casted giant magnetostrictive material only can manage 0-2 kHz.

Giant magnetostrictive alloys made of terbium, dysprosium and iron are usually called Terfenol-D. The magnetostriction of Terfenol-D, similar to most giant magnetostrictive materials, is highly anisotropic. Clark and others have mentioned that in absence of single crystals, this anisotropy demands that textured polycrystalline systems be fabricated for maximum performance (see, e.g. Clark, A. E., Magnetostrictive Rare Earth-Fe₂ Compounds, in Ferromagnetic Materials, E. P. Wohlfarth ed., (North-Holland Pub. Co. 1980).

Composite forms of giant magnetostrictive materials such as Terfenol-D are being investigated to obtain materials with improved frequency response and durability as compared to comparable monolithic materials. The only currently available system to allow for frequency response of Terfenol-D above 1-2 kHz is the laminated system (see, e.g. Snodgrass et al., 1997, Journal of Alloys and Compounds, 258, pp. 24-29). This system has been employed to produce sonar transducers but is expensive and has a limited upper bound of frequency response (see, e.g. Butler et al., OCEANS 2000 MTS/IEEE Conference Proceedings, Providence R.I., pp. 1469-1475). The controlling geometry in the laminate system is the thickness of the layers perpendicular to the field application direction (see, e.g. Kendall et al., 1993, Journal of Applied Physics, 73 (10), pp. 6174-6176) and due to the brittleness of Terfenol-D, laminates may only produced with Terfenol-D layer thickness greater than ˜1 mm. Particulate composite magnetostrictive materials provide a solution to this problem because particles may be produced with much smaller diameters and thus can allow for increased frequency response. However, all composite systems have thus far produced much lower saturation strain output than the comparable commercially available monolithic materials.

Magnetostrictive composites have received considerable attention due to improvements in terms of frequency response, durability, and part geometry when compared to the comparable monolithic materials. Research efforts in this regard have concentrated on magnetostrictive particulate combined with either a polymer, or metallic matrix (see, e.g. Sandlund et al., Journal of Applied Physics, 75, pp. 5656-5658, 1994; Duenas et al., Journal of Applied Physics, 87, pp. 4696-4701, 2000; Lim et al., Journal of Magnetism and Magnetic Materials, 191, pp. 113-121, 1999; Pinkerton et al., Applied Physics Letters, 70, pp. 2601-2603, 1997; and Chen et al., Applied Physics Letters, 74, pp. 1159-1161, 1999). One key advantage associated with polymer matrix composite systems is an increased frequency range through lower conductivity, a characteristic which prevents eddy current loss. Moreover, composite materials are typically more easily machined than monolithic magnetostrictive materials and can be molded into specific sizes and shapes. While superior in these areas, previously described magnetostrictive composites exhibit lower saturation magnetostriction than the comparable monolithic materials.

An early report of composite magnetostrictive materials is found in Sandlund et al., 1994, Journal of Applied Physics, 75, pp. 5656-5658. This reference reports using a polymer binder, particle alignment during fabrication, and high volume fraction composites to produce materials that exhibited up to 800 microstrain (as compared to 1800 microstrain of commercially available Terfenol-D). More recent studies have demonstrated even higher strain (˜1150 10⁻⁶) may be obtained using a polymer matrix, for example with low volume fraction, and reduced void content. Such studies represent continuing efforts to improve this technology (see, e.g. Duenas et al., 2000, Journal of Applied Physics, 87, pp. 4696-4701; Duenas, T. A., and Carman, G. P., Journal of Applied Physics, Sep. 1, 2001 V. 90, Issue 5, 2433-2439; and Nercessian et al., 2001, “Magneto-Thermo-Mechanical Characterization of Magnetostrictive Composites,” Active Material: Behavior and Mechanics, SPIE Smart Structures and Materials, Newport Beach, Calif.; McKnight, G. and Carmen G. P., Material Transactions, Vol. 43 No. 5 (2002) pp. 1008-1014; Or et al. 10th AIAA/ASME/AHS Forum, April 2002, paper no. AIAA-2002-1552, pp 1-10; McKnight, G. and Carman G. Proceedings of 2001 ASME IMECE, Adaptive Structures and Material Systems Symposium, Nov. 11-16, 2001, pp. 1-6; and Nercessian, N., and Carman, G. P., Adaptive Structures and Material Systems, v. 60, Orlando, Fla., November 2000, pp. 139-146, the contents of each of which are incorporated herein by reference).

Particulate composite materials described in the art traditionally have a random distribution of particulate geometrically; that is the particulate does not form an organized pattern or structure. U.S. Pat. No. 5,792,284 discloses particulate composite magnetostrictive composites where the particulate has been placed in a magnetic field during processing, to align the particulate. This process results in an anisotropic composite by giving an anisotropic order to the particles in the direction where the magnetic field was applied during processing. However, this process does not result in crystallographic orientation of the particles. A similar concept was investigated by Malekzadeh (U.S. Pat. No. 4,152,178), where a sintered rare earth-iron material was made by first applying a magnetic field to the particles and then compacting this material to form the green compact. However, this compact is then sintered to produce a solid material, and not a composite material.

As noted above, there is a need in the art for composite magnetostrictive materials having improved characteristics such as frequency response and durability as compared to the analogous monolithic materials. This need is fulfilled by the invention that is described below.

### SUMMARY OF THE INVENTION

The invention described herein provides magnetostrictive composites and methods for producing these composites that overcome the above disadvantages in the art. The present invention overcomes limitations in the existing art by producing a crystallographic alignment of particles in a composite material through the application of magnetic, electric or mechanical fields in specific contexts. The composite materials produced by such processes exhibit physical properties that are superior to those observed in composites lacking a crystallographic orientation of particles.

The methods and compositions of the present invention can be used in a number of contexts. The invention disclosed herein can be utilized, for example, in contexts where the properties of the particulate are anisotropic and where improved composite material properties can be obtained through a preferred crystal orientation of the particles within the composite (as compared to a random orientation of the particles within a composite). A preferred embodiment of the invention is a crystallographic alignment of particles in a composite material through the application of magnetic, electric or mechanical fields (preferably magnetic fields) combined with shape anisotropy. This process results in the generation of a composite that exhibits a number of highly preferred material properties due to the orientation of the particulate reinforcement along a preferred crystallographic axis. In an alternative embodiment of the invention, magnetocrystalline anisotropy can be employed in methods to generate composites having analogous properties.

An illustrative embodiment of the invention is one that utilizes particles of the highly magnetostrictive compound, Terfenol-D (Th_{0.27}Dy_{0.73}Fe₂). The magnetostriction of Terfenol-D is highly anisotropic with λ₁₁₁=1600 microstrain and λ₁₀₀=90 microstrain. As described in detail herein, a composite with [112] preferred orientation has been fabricated using the shape anisotropy orientation method described above. This composite exhibits a larger saturation strain than non-oriented composites and decreased operating fields. The increase in saturation magnetostriction over similar non-oriented magnetostrictive composites is 35-40%. This has improved the properties of the particulate composite form of magnetostrictive composites to near that of the commercially available form while simultaneously decreasing the electrical resistance by 2-4 orders of magnitude. The properties observed with magnetostrictive composites manufactured in this manner such as the reduction in resistance allows for a number of novel applications, for example their use in the operation of a vibrating device incorporating the magnetostrictive material at high frequency (10-100 kHz).

The invention described herein can be used to manufacture particulate composite materials with superior properties over those of traditional particulate composites. The improvement is a result of obtaining a preferential orientation of the particles along a crystallographic axis that maximizes a property of interest. This concept is illustrated in practice in the Terfenol-D particulate composite system described herein. This material is of particular interest to artisans in the field of engineering who, for example desire a high power density actuation materials capable of operating in the frequency regime 0-100 kHz. Current commercially available laminated Terfenol-D is limited to a frequency of 5-10 kHz. Applications for the magnetostrictive particulate composite materials disclosed herein include their use in SONAR transducers, their use in the general vibration reduction of machining equipment, their use in ultrasonic vibrators and the like.

### BRIEF DESCRIPTION OF THE DRAWINGS

FIG. 1 provides a comparison of strain output for the OPC, NOPC, and monolithic Terfenol-D at a constant compressive preload of 8 Mpa.

FIG. 2 provides a comparison of strain output for the OPC, NOPC, and monolithic Terfenol-D at a constant compressive preload of zero preload (0 Mpa).

FIG. 3 illustrates magnetization behavior at constant compressive preload for the OPC, NOPC, and monolithic material.

FIG. 4 provides a comparison of parabolic magnetization models to experimental data (8 MPa and 12 MPa) for the OPC (FIG. 4) and NOPC (see FIG. 5 below) assuming crystal alignment along the [112] axis for the OPC, [111] alignment for the NOPC, and for comparison assuming polycrystalline behavior. Sandlund's model with strain proportional to volume fraction has also been given. Experimental data nomenclature is identical to FIG. 3.

FIG. 5 provides a comparison of parabolic magnetization models to experimental data (8 MPa and 12 MPa) for the OPC (see FIG. 4 above) and NOPC (FIG. 5) assuming crystal alignment along the [112] axis for the OPC, [111] alignment for the NOPC, and for comparison assuming polycrystalline behavior. Sandlund's model with strain proportional to volume fraction has also been given. Experimental data nomenclature is identical to FIG. 3.

FIG. 6 illustrates the average magnetostriction at various constant loads for OPC, NOPC, and monolithic materials as a function of applied field.

FIG. 7 provides a photo of the oriented particle composite specimen showing the oriented particles where the orientation direction is vertical.

FIG. 8 illustrates average magnetostriction as a function of applied field for oriented, non-oriented and monolithic materials at various compressive prestress. The peak magnetostriction for the OPC, NOPC, and monolithic are 1550, 1200, and 1800 ppm, respectively.

FIG. 9 illustrates magnetostriction as a function of magnetization at various compressive prestress for oriented and non-oriented particle composites as compared to the monolithic. The particle volume fractions of the OPC and NOPC are 25% and 33%, respectively.

FIG. 10 provides a magnetization strain model for the [112] oriented particle composite with predictions for alignment along [112] and polycrystalline.

FIG. 11 provides a magnetization strain model for the non-oriented particle composite with predictions for alignment along [111] (in the case of magnetocrystalline anisotropy determining orientation) and polycrystalline (in the case of shape anisotropy determining particle orientation).

FIG. 12 illustrates maximum magnetostriction predicted in a composite by rule of mixtures model as a function of volume fraction.

FIG. 13(a) demonstrates the aligned and non aligned particle geometry as investigated by Sandlund. FIG. 13(b) shows the aspect ratio and crystallographic orientation of the particles used to prepare [112] oriented composites and compares these with randomly formed particles that produce composites with no preferred particle crystal orientation. FIG. 13(c) shows the [111] highly magnetostrictive direction in Terfenol-D which responds at two orders of magnitude larger response than the [100] direction which requires preferred crystal orientation to obtain the best magnetostrictive properties. Note that the illustrative embodiment disclosed in the examples below used [112] orientation because this material was readily available, and this provides superior performance to randomly oriented composites. The most preferred mbodiment for Terfenol-D is [111] orientation. FIG. 13(d) gives the preferred particle geometry to obtain preferred particle orientation using magnetocrystalline geometry instead of shape anisotropy.

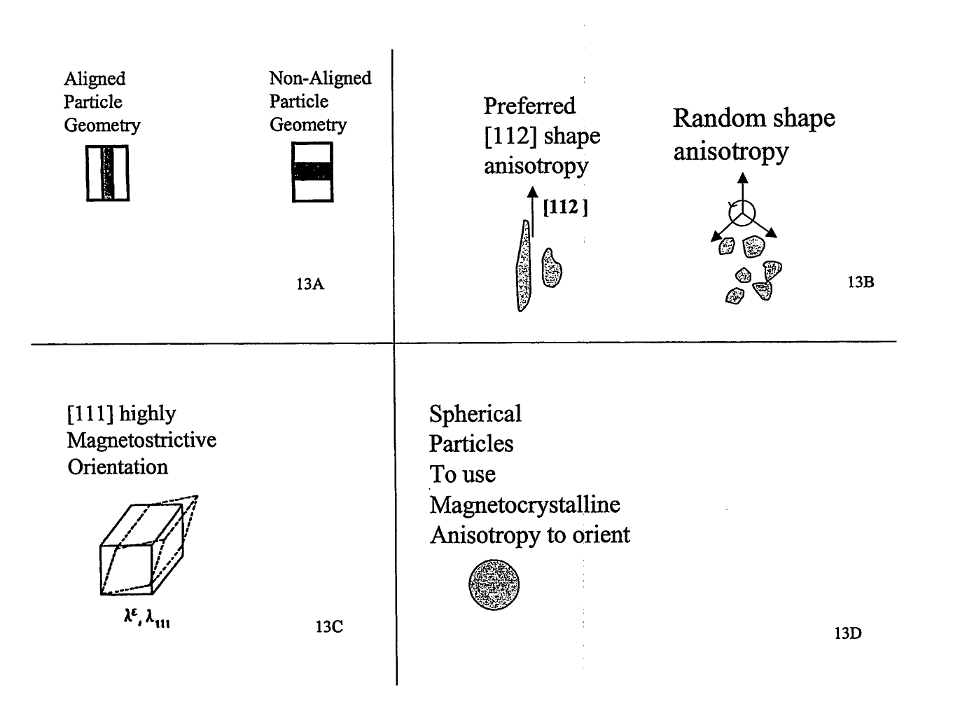

FIG. 14(a) shows the organization of particles in a composite generated by magnetically aligning the material before it is pressed isostatically and the binder has been cured (see, e.g. U.S. Pat. No. 5,792,284). This is accomplished by applying a magnetizing field along the working direction of the magnetostrictive powder composite. FIG. 14(b) shows the organization of particles in a composite generated by a method of forming a composite comprising a matrix material and a plurality of particles oriented along a specific crystal axis, the method comprising combining the matrix material with the particles, wherein the particles of the composite are selected to be ferromagnetic and to have an aspect ratio sufficient to align them along their longest dimension in the presence of a magnetic field; exposing the particles within the matrix material to a magnetic field sufficient to align them in a crystallographic orientation; and allowing the composite to form such that the particles exhibit a crystallographic orientation within the matrix material of the composite. FIG. 14(c) shows the organization of particles in a composite generated by a method of forming a composite comprising a matrix material and a plurality of particles oriented along a specific crystal axis, the method comprising combining the matrix material with the particles, wherein the particles of the composite are selected to be ferromagnetic and to have a magnetocrystalline anisotropy sufficient to overcome their shape anisotropy in the presence of a magnetic field; exposing the particles within the matrix material to a magnetic field sufficient to align them in a crystallographic orientation; and allowing the composite to form such that the particles exhibit a crystallographic orientation within the matrix material of the composite. In such methods, artisans typically employ a number of techniques to examine the specific orientation of particles within composites include microscopic examinations as well as those that employ x-ray diffusion technology. Alternatively, the orientation of particles can be assessed by analyzing the material properties of the composite. As noted below, composites having particles in a crystallographic orientation exhibit certain specific material properties that differ markedly from those of composites having particles that are not aligned in this manner.

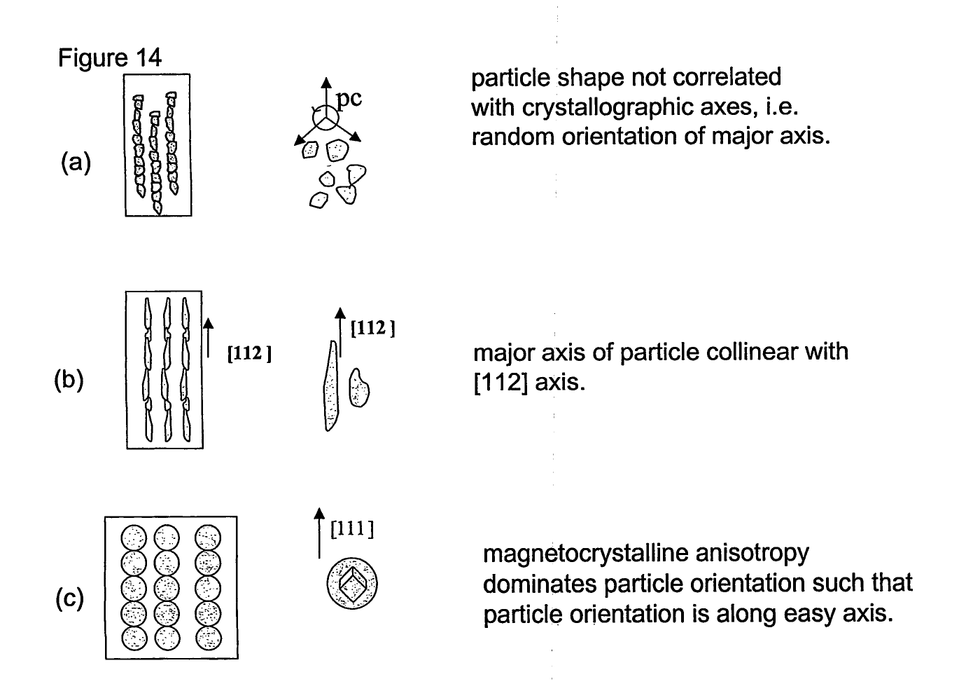

### DETAILED DESCRIPTION OF THE INVENTION

Unless otherwise defined, all terms of art, notations and other scientific terminology used herein are intended to have the meanings commonly understood by those of skill in the art to which this invention pertains (e.g. as defined in references such as DICTIONARY OF SCIENCE AND TECHNOLOGY, C. Morris ed. 1992 Academic Press). In some cases, certain terms are further defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art. As appropriate, procedures involving the use of commercially available kits and reagents are generally carried out in accordance with manufacturer defined protocols and/or parameters unless otherwise noted.

The invention disclosed herein provides methods for aligning particulate materials within a composite in a crystallographic orientation as well as composites made by such methods. The inventive composites having a crystallographic alignment of particles can be generated by a number of methodologies that involve the application of magnetic, electric or mechanical fields to particles within a matrix of the composite so that the particles assume a preferred orientation. In these contexts, the particles used to generate the composites are selected to have properties that facilitate their orientation in specific contexts, for example those associated with shape anisotropy and/or magnetocrystalline anisotropy. In one example of such methods, shape anisotropy can be utilized in as a means to align particles within the composites along their longest geometric axis. In an alternative example of such methods, magnetocrystalline anisotropy can be utilized as a means to align particles within the composites along a specific magnetic axis. Specific illustrative embodiments of the invention are discussed in detail below.

Illustrative embodiments of the invention disclosed herein include methods for utilizing shape anisotropy to preferentially orient particles within a composite as discussed in the examples below. Briefly, an arbitrary shaped particle isolated in a field possesses preferred orientations that minimize an energy condition for the particle/field system. A typical example of such a system is a magnetic particle of arbitrary dimension immersed in non-magnetic medium. If a magnetic field is applied to this system, a torque will be exerted on the particle such that its motion will minimize the demagnetization energy of the particle. For example, an ellipsoid shape particle will tend to rotate such that the major axis is aligned with the magnetic field. The source of this torque lies in the demagnetization energy associated with a particle. In this context, the disclosure provided herein teaches methods for utilizing shape anisotropy to preferentially orient particles within a composite.

For magnetic particles, a second force (in addition to shape anisotropy) exists that can also be utilized to orient particles within the composites described herein. This second force is the due to the magnetocrystalline anisotropy of the particulate material. Consequently, further embodiments of the invention include methods for utilizing magnetocrystalline anisotropy to preferentially orient particles within a composite. For example, if a particle used in such composites has either a large magnetocrystalline anisotropy (such as a hard ferromagnetic particle) or has very little shape anisotropy (such as a sphere), the magnetocrystalline anisotropy of that particle can be used to orient it along the axis of easy magnetization. For a spherical ferromagnetic particle of a single grain, the magnetocrystalline anisotropy will constrain the magnetization along certain easy crystal directions. If these spherical particles are placed in a magnetic field, they will orient such that the magnetization of each particle is collinear with the applied field. If the magnetocrystalline anisotropy is sufficiently strong, the magnetization will remain in the easy direction and the particle will physically rotate such that a preferred crystal orientation among all particles relative to the applied field is achieved.

Composites of the invention are typically generated by combining particles (e.g. Terfenol-D particles) having specific properties with a matrix (e.g. a polymer such a vinyl ester) and then exposing these particles to a magnetic and/or electric and/or mechanical field in a manner that allows them to assume a preferred orientation within the matrix. In general one can divide up active particulate materials that are responsive to the general methods disclosed herein into three general classes, ferromagnetic, ferroelectric, and ferroelastic. Ferromagnetic materials respond to a magnetic field, ferroelectric materials respond to an electric field, and ferroelastic materials respond to a mechanical field. In the preferred embodiment disclosed in the examples below, we teach that a magnetic field can be used to crystallographically orient a magnetostrictive (i.e. ferromagnetic material) in a composite material. In this context, because a material's response is a function of crystallographic orientation, by precisely directing the orientation of the particles within the composite system material, one can improve the material properties of the composite system.

Similar to ferromagnetic materials, ferroelectric and ferroelastic material's response is a function of crystallographic orientation. Therefore, another embodiment of the invention includes using magnetic fields to orient them (e.g. ferroelectric and/or ferroelastic materials) in a composite system. Coating the ferroelectric or ferroelastic materials with a ferromagnetic substance and using a magnetic field to crystallographically orient the material within a composite represents a preferred approach to accomplish this but does not exclude other approaches. Furthermore, as ferroelectric and ferroelastic materials respond to other fields (e.g. ferroelectrics respond to electric fields), an electric field could be substituted for a magnetic field in the appropriate context in order to achieve a crystallographically oriented ferroelectric composite. Similarly, a mechanical field could be substituted for a magnetic field in the appropriate context in order to achieve a crystallographically oriented ferroelastic composite.

Composite systems in which the particles of the system are preferentially placed into a crystallographic orientation within the composite matrix have a number of surprising and advantageous properties. For example, such composites typically exhibit an increase in saturation magnetostriction over similar non-oriented magnetostrictive composites in ranges of up to 35-40%. In this context, a preferred embodiment of the invention is a composite having a crystallographic orientation of particles and exhibiting about a 10%, 20%, 30% or 40% increase in saturation magnetostriction over a control composite having non-oriented particles. In addition, composites having a crystallographic orientation of particles typically exhibit a saturation magnetostriction that approaches or even exceeds that of the comparable monolithic materials. In this context, a preferred embodiment of the invention is a composite having a crystallographic orientation of particles and exhibiting a saturation magnetostriction that is about 70%, 80%, 90%, 100%, 110%, 120%, 130%, 140% or 150% of the saturation magnetostriction observed with the comparable monolithic material.

Composite systems in which the particles of the system are preferentially placed into a crystallographic orientation within the composite matrix have a number of additional advantageous material properties over comparable composites having non-oriented particles. Such composites can exhibit, for example a decrease in electrical resistance of up to about 2-4 orders of magnitude. In this context, a preferred embodiment of the invention is a composite having a crystallographic orientation of particles and exhibiting about a 1 fold, 2 fold, 3 fold or 4 fold reduction in electrical resistance as compared to control composites having non-oriented particles. In addition, composite systems in which the particles of the system are preferentially placed into a crystallographic orientation are also shown to exhibit superior actuation, energy absorption and energy harvesting properties when compared to control composites having non-oriented particles. In this context, a preferred embodiment of the invention is a composite having a crystallographic orientation of particles and exhibiting at least a 10% increase in actuation potential and/or energy absorption and/or energy harvesting properties as compared to control composites having non-oriented particles. Properties such as saturation magnetostriction and/or actuation potential and/or energy absorption and/or energy harvesting are preferably assessed in one of the wide variety of methodologies typically used by artisans in this filed to examine these material characteristics (e.g. coupling coefficients to examine energy harvesting etc.).

A variety of particles and composite matrixes can be used to generate the composites disclosed herein. For example, while Terfenol-D is disclosed as an illustrative particulate for use in the composites disclosed herein, a wide variety of ferromagnetic and/or ferroelectric and/or ferroelastic particles can be used to make the inventive composites disclosed herein. Artisans can utilize other particle compositions, for example those disclosed in Mechanics of Composite Materials by Robert M. Jones—Taylor and Francis Publishing 2nd edition, which is incorporated herein by reference. In addition, U.S. Pat. No. 4,378,258 to Clark et al. discusses ErFe₂ and TbFe₂ magnetostrictive compositions produced by mixing the magnetostrictive materials with epoxy resins, followed by curing.

As is known in the art, the volume of the particles within the matrix of the composite can vary. U.S. Pat. No. 4,378,258 teaches that good magnetostrictive properties and good secondary properties are obtained when the magnetostrictive material constitutes 20-60% by volume of the composition. U.S. Pat. No. 5,792,284 teaches that the particulate material can constitute even more than 60% of the volume of the composite (as identified by Clark et al.) and can constitute up to about 70% to about 80% by volume of the composition.

A wide variety particle binding matrices are can be used to generate the composites disclosed herein. Illustrative matrices include a large number of polymers (e.g. vinyl ester as disclosed in the examples), metals, ceramics and the like that are typically used to form composite materials. References describing typical matrix materials useful in binding the various particulate materials disclosed herein include Mechanics of Composite Materials by Robert M. Jones—Taylor and Francis Publishing 2nd edition, which is incorporated herein by reference.

In addition to composites having a relatively uniform particulate materials (e.g. Terfenol-D), skilled artisan further understand that hybrid composites comprising combinations of multiple types of particles (for example those having different ferromagnetic and/or ferroelectric and/or ferroelastic properties) are within the scope of the present invention. Skilled artisans further understand that hybrid composites comprising combinations of multiple matrix materials having varying characteristics are within the scope of the present invention. Skilled artisans further understand that composites of the invention can be formed by exposing the particles to more than one field in order to influence the particles within the composite (e.g. by exposing a uniform population or, alternatively, a mixed population of particles to, for example a magnetic as well as an electric and/or a mechanical field).

The invention disclosed herein has a number of specific embodiments. An illustrative embodiment of the invention that is discussed in the examples below consists of a method of utilizing shape anisotropy to produce a composite comprising a matrix (e.g. a polymer such as vinyl ester or the like) and a plurality of particles (e.g. of a magnetostrictive material such as Terfenol-D), wherein the particles exhibit a crystallographic alignment within the matrix. In this method, the matrix of the composite can be selected from any one of the wide variety of materials known in the art while the particles of the composite are selected to be ferromagnetic and to have an aspect ratio sufficient to align them along their longest dimension in the presence of a magnetic field. In this context, the composites are generated by combining the particles with the matrix and exposing the particles within the matrix to a magnetic field sufficient to align them in a crystallographic orientation (i.e. so that a composite having particles in this orientation is produced). A closely related embodiment of the invention is a composite composition that is produced by this method. For example, a preferred composition of the invention comprises a composite that consists of a matrix combined with a plurality of particles, wherein the particles are ferromagnetic and have an aspect ratio sufficient to align them along their longest dimension in the presence of a magnetic field and further wherein the particles occur in a crystallographic orientation within the matrix.

Another illustrative embodiment of the invention consists of a method of utilizing magnetocrystalline anisotropy to produce a composite comprising a matrix (e.g. a polymer such as vinyl ester and the like) and a plurality of particles (e.g. of a magnetostrictive material such as Terfenol-D), wherein the particles exhibit a crystallographic alignment within the matrix. In this method, the matrix of the composite can be selected from any one of the wide variety of materials known in the art while the particles of the composite are selected to have a magnetocrystalline anisotropy sufficient to overcome shape anisotropy (a selection which can be based on the shape and/or the constituent properties of the particles) in a manner that allows them to achieve a crystallographic orientation within the matrix the presence of a magnetic field. In this context, the composites are generated by combining the particles with the matrix and exposing the particles within the matrix to a magnetic field sufficient to align them in a crystallographic orientation (i.e. so that a composite having particles in this orientation is produced). A closely related embodiment of the invention is a composite composition that is produced by this method. For example, a preferred composition of the invention comprises a composite that consists of a matrix combined with a plurality of particles, wherein the particles exhibit a geometry (e.g. a sphere) and/or a composition (e.g. a hard ferromagnetic particle) sufficient to overcome forces relating to shape anisotropy in the presence of a magnetic field and further wherein the particles occur in a crystallographic orientation within the matrix.

A preferred embodiment of the invention is a method of forming a composite comprising a matrix material and a plurality of particles oriented along a specific crystal axis, the method by combining the matrix material with the particles, wherein the particles of the composite are selected to be ferromagnetic and to have an aspect ratio sufficient to align them along their longest dimension in the presence of a magnetic field. In this method, the particles within the matrix material are exposed to a magnetic field that is sufficient to align them in a crystallographic orientation as the composite is generated. This results in the formation of a composite having particles that exhibit a crystallographic orientation within the matrix material of the composite. Understandably, a closely related embodiment of the invention is a composite produced by following this methodology. Such embodiments of the invention include for example a composition comprising a matrix material combined with a plurality of particles, wherein the particles are ferromagnetic and have an aspect ratio sufficient to align them along their longest dimension in the presence of a magnetic field and further wherein the particles exhibit a crystallographic orientation within the matrix material.

The particles and the matrix materials of these composite can be made from any one of a wide variety of materials known in the art. In specific embodiments of the invention, the particles of the composite are comprised of Terfenol-D and the matrix material comprises a polymeric material such as a vinyl ester thermosetting polymer. Alternative embodiments of the invention include those formed with multiple types of particles and/or particles having multiple preferred material properties (e.g. a ferroelastic or ferroelectric material coated with a ferromagnetic material etc) as well as formed with multiple types of a matrix/binder that is combined with the particles.

As disclosed herein, these composites which are formed by processes involving shape anisotropy can exhibit a number of highly preferred material properties. In one such embodiment, the composite is formed to exhibit at least about a 10% increase in saturation magnetostriction over a control composite having non-oriented particles. In another embodiment, the composite is formed to exhibit a saturation magnetostriction that is at least about 70% of the saturation magnetostriction exhibited by the comparable monolithic material. In yet another embodiment, the composite is formed to exhibit at least about a 1 order of magnitude decrease in electrical resistance as compared to a control composite having non-oriented particles and/or a comparable monolithic material.

Yet another embodiment of the invention is a method of forming a composite comprising a matrix material and a plurality of particles oriented along a specific crystal axis by combining the matrix material with the particles, wherein the particles of the composite are selected to be ferromagnetic and to have a magnetocrystalline anisotropy sufficient to overcome their shape anisotropy in the presence of a magnetic field. In this method, the particles within the matrix material are exposed to a magnetic field that is sufficient to align them in a crystallographic orientation as the composite is generated. This results in the formation of a composite having particles that exhibit a crystallographic orientation within the matrix material of the composite. Understandably, a closely related embodiment of the invention is a composite produced by following this methodology. Such embodiments of the invention include for example a composition comprising a matrix material combined with a plurality of particles, wherein the particles are ferromagnetic have a magnetocrystalline anisotropy sufficient to overcome their shape anisotropy in the presence of a magnetic field and further wherein the particles exhibit a crystallographic orientation within the matrix material. In methods which involve magnetocrystalline anisotropy (as opposed to shape anisotropy) the particles of the composite are selected to have a magnetocrystalline anisotropy sufficient to overcome their shape anisotropy in the presence of a magnetic field by geometrical criteria (e.g. has very little shape anisotropy as do spherical particles) or by compositional criteria (e.g. has a large magnetocrystalline anisotropy as do hard ferromagnetic particles).

As disclosed herein, these composites which are formed by processes involving magnetocrystalline anisotropy can exhibit a number of highly preferred material properties. In one such embodiment, the composite is formed to exhibit at least about a 10% increase in saturation magnetostriction over a control composite having non-oriented particles. In another embodiment, the composite is formed to exhibit a saturation magnetostriction that is at least about 70% of the saturation magnetostriction exhibited by the comparable monolithic material. In yet another embodiment, the composite is formed to exhibit at least about a 1 order of magnitude decrease in electrical resistance as compared to a control composite having non-oriented particles and/or a comparable monolithic material.

A broad embodiment of the invention is a method of forming a composite comprising a matrix material and a plurality of particles oriented along a specific crystal axis, the method comprising combining the matrix material with the particles, wherein the particles are selected to exhibit properties that allow them to organize into a crystallographic orientation in the presence of a magnetic, electric or mechanical field, and then exposing the particles within the matrix material to a magnetic and/or an electric and/or a mechanical field that is sufficient to align them in a crystallographic orientation. In this method, the particles within the matrix material are exposed to a magnetic field that is sufficient to align them in a crystallographic orientation as the composite is generated. This results in the formation of a composite having particles that exhibit a crystallographic orientation within the matrix material of the composite. Understandably, a closely related embodiment of the invention is a composite produced by following this methodology. In a specific embodiment of the invention, the particles are selected to exhibit ferromagnetic properties that allow them to organize into a crystallographic orientation in the presence of a magnetic field. Alternatively, the particles are selected to exhibit ferroelectric properties that allow them to organize into a crystallographic orientation in the presence of an electric field. Alternatively, the particles are selected to exhibit ferroelastic properties that allow them to organize into a crystallographic orientation in the presence of a mechanical field. As noted above, composites which are formed by such processes can exhibit a number of highly preferred material properties. For example, in preferred embodiments, the composite is formed to exhibit at least about a 10% increase in saturation actuation/sensing strain over a control composite having non-oriented particles or at least about 70% of the saturation actuation/sensing strain exhibited by a comparable monolithic material.

Another embodiment of the invention is a multiferroic composite that is formed by methods where magnetic and/or an electric and/or a mechanical fields are coupled to generate a hybrid composite having a plurality of particles with different material properties. In such embodiments, one or more of the distinct populations of particles (e.g. ferromagnetic, ferroelastic and/or ferroelectric particle populations) is crystallographically oriented in the composite in response to a magnetic and/or an electric and/or a mechanical field that is applied to the particle(s) during formation of the composite. As noted above, composites which are formed by such processes can exhibit a number of highly preferred material properties.

Yet another embodiment of the invention employs particles comprising ferromagnetic shape memory alloy materials, such as the Ni₂MnGa system. These materials exhibit strain in response to an applied magnetic field due to the movement of twin boundaries. However, the effect has only been observed in single crystal specimens and cannot be observed in much less expensive polycrystalline specimens. The invention described herein may therefore be employed to create single crystal behavior from many small single grain particles. This embodiment of the invention can allow FSMA materials to be produced less expensively, produced in much larger sizes than currently available, and also limit eddy current effects from excessively heating the actuator material. In an illustrative embodiment of this aspect of the invention, shape anisotropy with high aspect ratio particles, or magnetocrystalline anisotropy with spherical shaped particles can be used to provide preferred crystallographic orientation and significantly improved properties over a non-preferred orientation composite.

Kits designed to facilitate the methods of the invention and/or having the compositions of the invention are within the scope of the invention. Such kits may comprise a carrier means being compartmentalized to receive in close confinement one or more container means such as vials, tubes, and the like, each of the container means comprising one of the separate elements to be used in the method. For example, one of the container means may comprise particle as described above for use in the methods disclosed herein. Such kits of the invention will typically comprise the container described above and one or more other containers comprising materials desirable from a commercial and user standpoint, including reagents, diluents, and package inserts with instructions for use. A label may be present on the container to indicate that the composition is used for a specific application.

The examples provided in the next section illustrate the superior properties of the composites disclosed herein over the composites previously described in the art by providing illustrative embodiments of magnetostrictive composite materials that overcome limitations of monolithic forms such as frequency response and durability. Briefly, as noted above, previously described magnetostrictive composite materials show a significantly decreased saturation strain as compared to the monolithic materials. Despite this disparity in saturation strains, little work has been performed with the intent to align particles along specific crystal axes in particulate composite materials. Previously, researchers argued that magnetocrystalline anisotropy along the [111] easy magnetic axis would tend to orient particles along this direction when subjected to a field during processing (see, e.g. Sandlund et al., 1994, Journal of Applied Physics, 75, pp. 5656-5658). However based on reported data, magnetostriction of these composites appears to more closely follow polycrystalline (saturation magnetostriction=1200 microstrain) rather than oriented [111] (saturation magnetostriction=2400 microstrain) behavior. This observation was confirmed at UCLA where studies of individual particles in a magnetic field indicated that shape anisotropy and not magnetic anisotropy dominates orientation. Shape anisotropy is defined as the force that tends to align a particle along the longest geometric axis. The observed dominance of shape anisotropy is contrary to prior beliefs that magnetocrystalline anisotropy yields preferential orientation of Terfenol-D particles along the [111] easy magnetic axis.

The disclosure provided herein therefore overcomes limitations in the existing technology by teaching methods for manufacturing composites with particle orientation along a specific crystal axis as well as composites produced by such methods. In an illustrative embodiment of the invention using Terfenol-D as described in the examples below, shape anisotropy is used during the manufacture of the magnetostrictive composite to orient needle shaped particles along their longest dimension, near the [112] direction. Measurements reveal that the saturation magnetostriction for composites generated using such methods increases from ˜1200 ppm for a non-oriented composite (at 12 MPa compressive stress) to over 1550 ppm for a [112] oriented composite (under 12 MPa compressive stress). This is the largest magnetostriction reported as yet for a composite material.

Without being bound by a specific theory, one significant observation provided by this disclosure is that the dominant influence on the orientation of particles having ferromagnetic properties (e.g. Terfenol-D) aligned during manufacture is the shape anisotropy and not the magnetocrystalline anisotropy. Furthermore, this disclosure teaches that the necessary applied fields to reach similar magnetostriction have been reduced in the oriented particle composites as compared to non-oriented particle composites. In addition, as disclosed below, a rule of mixtures model is used to demonstrate that the composite exhibits nearly the maximum rule of mixtures prediction for magnetostriction.

Studies of single crystal Terfenol-D demonstrated that magnetostriction is highly anisotropic with λ₁₁₁>>λ₁₀₀ (see, e.g. Teter et al., Journal of Applied Physics, 67, pp. 5004-5006, 1990; Wang et al., Journal of Magnetism and Magnetic Materials, 218, pp. 198-202, 2000; and Busbridge et al., IEEE Transactions on Magnetics, 35, pp. 3823-3825, 1999). The cubic saturation magnetostriction constants were determined experimentally as λ₁₁₁=1640 and λ₁₀₀=90. The saturation magnetostriction along the commercially important [112] easy growth axis was experimentally measured as λ₁₁₂=1200 (see, e.g. Wang et al., Journal of Magnetism and Magnetic Materials, 218, pp. 198-202, 2000). These constants are the saturation strain at full magnetization along the prescribed axis starting from a fully random magnetization state. If the magnetization is rotated fully through 90° with respect to the measurement direction, then the maximum magnetostriction is λₘₐₓ=λ_{∥}−λ_{⊥}=3/2λₛ. The polycrystalline saturation magnetostriction may be derived from averaging cubic single crystal theory (see, e.g. Becker, R. Doring W., Ferromagnetismus, Verlag von Julius Springer, Berlin, pp. 128-142, 1943). The saturation magnetostriction for a cubic polycrystal is given by λ_{pc}=2/5λ₁₀₀+3/5λ₁₁₁ and is equal to 1020 ppm for Terfenol-D. By comparing λ_{pc} to λ₁₁₂ and λ₁₁₁, one concludes that large increases in composite magnetostriction may be obtained by preferentially orienting particles along a specific crystal axis. However, little work has been performed with the specific intent to obtain crystallographic orientation of particles in the composite material. Previously, researchers argued that magnetocrystalline anisotropy along the easy magnetic axis would tend to orient particles along their magnetically easy direction when subjected to a field during processing (see, e.g. Engdahl, G., Handbook of Giant Magnetostrictive Materials, Academic Press, Inc., 1999). However based on reported data, magnetostriction of these composites appears to more closely follow polycrystalline (λ_{∥}−λ_{⊥}=1500 ppm) rather than oriented [111] (λ_{∥}−λ_{⊥}=2400 ppm) behavior. This observation was confirmed at UCLA where studies of individual particles in magnetic field indicated that shape anisotropy dominates orientation. These observations are contrary to prior beliefs that magnetocrystalline anisotropy yields preferential orientation of Terfenol-D particles along their easy magnetic axis.

Therefore, in preferred embodiments of this disclosure discussed in the examples the preferential orientation of particles within a composite is modulated utilizing shape anisotropy. For this purpose needle-shaped particles are made from commercially available [112] oriented stock. A composite material was fabricated from these particles along with a control composite made from random shaped ball-milled particles. Studies reveal that a [112] crystallographically oriented composite approaches the saturation magnetostriction of the [112] oriented material. This increases the saturation strain of composite materials from 1000 to 1550 ppm, which is a 55% increase over the highest previously reported composite magnetostriction (see, e.g. Duenas et al., Journal of Applied Physics, 87, pp. 4696-4701, 2000). Using this technique commercially produced textured polycrystalline material with a dominant orientation along a [112] direction yields a maximum magnetostriction in excess of 1800 microstrain measured using a compressive preload of 10-20 MPa. The theoretically predicted maximum magnetostriction for a polycrystalline material for a magnetization rotation from perpendicular to parallel to the measurement direction is given for cubic materials λ_{pc}2/5λ₁₀₀+3/5λ₁₁₁ and is equal to 1500 microstrain. However, our experimental tests for saturation strain with a 8 MPa preload yielded only 1200 microstrain.

As illustrated in the examples below, the magnetization-strain measurements indicate that the strain in the oriented composite is proportional to the λ₁₁₂ saturation magnetostriction while the non-oriented composite is proportional to the polycrystalline saturation magnetostriction, λ_{pc}. In addition, the fields necessary for equivalent magnetostriction in the oriented particle composite are reduced when compared to the non-oriented composite, though both require higher fields than commercially available monolithic Terfenol-D.

The magnetostrictive composites disclosed herein can be utilized in a variety of applications that typically employ such materials including include SONAR transducers, the vibration reduction of machining equipment, and ultrasonic vibrators. In a preferred use, the magnetostrictive composites disclosed herein are used in acoustic underwater sound projectors for high frequencies. Alternatively, the magnetostrictive composites disclosed herein are used in acoustic projectors for ultrasound applications (20-60 kHz). In another application, the magnetostrictive composites disclosed herein are used in vibration generators (0-60 kHz). In yet another application, the magnetostrictive composites disclosed herein are used in positioners (e.g. to generate fast, high precision motion). In yet another application, the magnetostrictive composites disclosed herein are used in wide bandwidth sound projectors and vibrators in which the amplitude does not change with frequency or load, which is the case with conventional electromagnets.

The present invention is further detailed in the following Examples which are offered by way of illustration and are not intended to limit the invention in any manner. All patent and literature references cited in the present specification are hereby incorporated by reference in their entirety. For purposes of clarity, certain techniques that are well known and well described in the art are reproduced herein.

### EXAMPLES

### Illustrative Example 1

A. Protocols

Two different types of composites (oriented and non-oriented) were manufactured for this example. The composites, along with a monolithic [112] Terfenol-D sample, were tested under combined magneto-mechanical loading at constant ambient temperature. Data recorded include load, strain, flux, and magnetic field. The research focus was to understand the role of crystallographic orientation on the magnetostriction in composite materials. In the following paragraphs, the fabrication and testing approach is described in detail.

In this example, particle crystal orientation along crystal direction was accomplished with particle shape anisotropy. Thus it was necessary to produce particle shapes that provided orientation along the desired crystallographic direction. For Terfenol-D this direction corresponds to the direction of maximum magnetostriction or the [111]. However, commercially available material is only produced with the orientation axis primarily along the [112] direction. Therefore, particles were produced with [112] orientation. Needle shaped particles were produced using a stock cylindrical rod of commercially available Terfenol-D transducer material. This material was milled along the rod axis using the dendritic microstructure to produce pieces of Terfenol-D with a needle shape (see, e.g. Verhoeven et al., Metallurgical Transactions A, 18A, pp. 223-232, 1987). These particles had aspect ratios of 2:1 or greater, and long axis dimensions close to the [112] direction. The size ranged from 100 to 500 microns long and from 50 to 100 microns wide. In comparison, commercially available polydistributed ball-milled particles had roughly cubic dimensions of less than 300 microns.

Composite specimens were prepared from both the commercially available ball milled particulate and the specially prepared needle shaped particle. For discussion purposes, the composite made with needle shaped particles will be referred to as the oriented particle composite (OPC), and the ball-milled particles as the non-oriented particle composite (NOPC). For each composite the particles were mixed with a vinyl ester thermosetting polymer and repeatedly degassed to eliminate voids. The composite slurry was then placed into an aluminum mold and a static magnetic field of approximately 100 kA/m was applied along the longitudinal direction of the composite using NdFeB magnets. This field has the effect of providing alignment of the particles into chain-like structures, which yields more favorable mechanical properties, and to provide orientation of the needle shaped particles along their longest dimension. For the purposes of this disclosure, particle alignment will refer to the formation of the particles into chain like structures, and particle orientation will refer to the crystallographic orientation of the particle within the composite.

For the needle shaped particle composite, visual inspection was used to ensure successful orientation. After curing at room temperature in the static field, the field was removed and the composites were post baked at elevated temperature (100° C.) to ensure fill cure of the polymer. One composite each of the OPC with needle shaped particles and NOPC with ball-milled particles was produced and then instrumented for testing using foil strain gages and 20 turn search coils. The nominal dimensions of the rectangular OPC were 2.0×2.0×1.0 cm and the nominal dimensions of the cylindrical NOPC were 1.0 cm diameter by 2 cm length. The strain in all samples is reported as the average value of 2 strain gages mounted to opposite sides of the specimen.

Tests were performed using an integrated mechanical-magnetic testing system. Mechanical loads were applied using a servo-hydraulic loading machine and magnetic fields were applied using a water-cooled solenoid. The magnetic flux was determined using a search coil and gaussmeter and the magnetic field was determined via a hall effect probe. Some problems were encountered in flux measurement due to flux leakage from the specimens caused by low permeability. In addition field irregularities could cause errors in the hall probe measurements, but these do not strongly affect the results.

B. Results

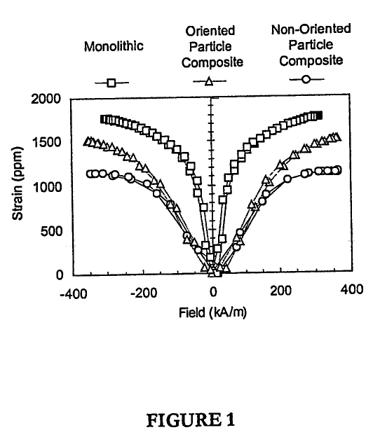

The results of magnetic field vs. strain for a constant stress compressive loading of 8 MPa for both the OPC and NOPC and the monolithic Terfenol-D are presented in FIG. 1. The effects of crystallographic alignment are clearly seen in the graph. The saturation strain of the OPC exceeds that of the NOPC considerably. The OPC reaches a saturation strain of almost 1600 ppm while the NOPC reaches only 1200 ppm as compared to the monolithic saturation of 1800 ppm. The highest previously reported magnetostriction of a composite material was 1000 ppm (see, e.g. Duenas et al., Journal of Applied Physics, 87, pp. 4696-4701, 2000). In FIG. 1, we observe that the field hysteresis in the composite and monolithic material is similar. In addition, the difference in hysteresis between the OPC and NOPC composites is minimal and thus does not appear to be a function of crystal orientation.

From single crystal Terfenol-D work, magnetostriction was found to be highly anisotropic and thus crystal alignment is critical to the saturation strain. Based on the results provided in FIG. 1, we make a similar observation for composites. That is, the OPC composites with crystal orientation closely along the [112] direction exhibited substantially larger magnetostriction than the NOPC composites. While there are some limitations to the orientation of the needle shaped particles including misalignment of the long axis of the particle with the [112] axis and friction during the particle alignment phase of fabrication, we observe that the magnetostriction at a constant 8 MPa compressive stress in the OPC reaches 86% of the saturation magnetostriction of the commercially available monolithic material. In comparison the NOPC saturates at 64% of the monolithic. In addition, though the reported strain in the OPC is the average of two strain gages, the actual strain gages showed a discrepancy of +/−100 ppm from this value, which the authors believe is due particle alignment differences. Thus, one side of the OPC composite saturated at a value of over 90% of the monolithic saturation strain, which indicates that composite magnetostrictive materials with improved particle orientation can be produced with saturation strain levels nearly equal to the original material.

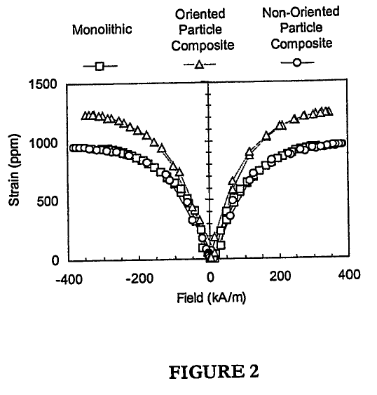

The results of magnetostriction versus magnetic field for all materials at 0 load are given in FIG. 2. The results show that the OPC saturates at 1200 ppm under no external load while the OPC and monolithic saturate at 950 ppm. All reported values are 2^{nd} cycle results that discard the effects of an unknown initial magnetic domain state on the magnetostriction. The monolithic material has very little preferred domain orientation since the only internal stresses come from stresses generated by crystal defects and material processing. This leads to a much lower saturation strain than when an external compressive load is applied that rotates domains perpendicular to the field axis (see, e.g. Clark et al. Journal of Applied Physics, 63, pp. 3910-3912, 1988). In the composite, an internal compressive stress is created in the particles during manufacture due to chemical shrinkage in the polymer during polymerization. The magnitude of this stress is a function of the volume fraction of particulate, the chemical shrinkage in the polymer, and the relative stiffness differences between the matrix and particulate. This stress creates an initial domain state that contains a larger fraction of non-180′ states than the monolithic material and leads to a larger saturation strain. Although the NOPC material possesses a similar internal pre-stress to the OPC, the saturation strain is limited by the polycrystalline-type distribution of particle orientation.

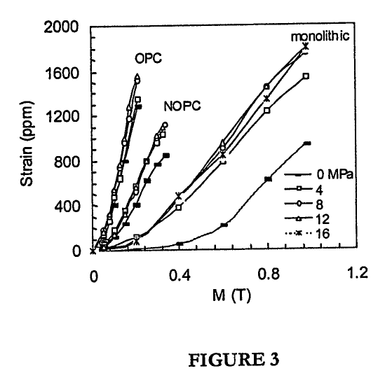

Examining the magnetization as a function of strain provides further insight into the crystal orientation. The average magnetization over a full magnetization cycle is presented in FIG. 3. We note that the magnetization of the composite materials is significantly lower than the monolithic Terfenol-D. In FIG. 3 the composite saturation magnetization, Mₛ^{c}, is proportional to the volume fraction of particulate, vₚ, as in
Mₛ^{c}=vₚMₛ^{T-D} (A)
The OPC had a particle volume fraction of 25% measured by weighting techniques, and the NOPC had a vₚ of 33%. The saturation magnetization of Terfenol-D is approximately 1.0 T (independent of crystal direction) at these fields. Based on equation (A) the predicted Mₛ^{c} for the 25% and 33% composites is 0.25 T and 0.35 T, respectively, which agrees well with the measured results. The measured values of 0.22 T and 0.33 T have errors attributed to small measurement errors in both flux density and field. Vibrating sample magnetometer testing has confirmed that the actual saturation magnetization in the composite materials is proportional to volume fraction. As can be seen in FIG. 3, if stress above a critical level is applied to rotate all domains into non-180° states, the magnetostriction strain as a function of magnetization is independent of stress. At stress levels below the critical level, some 180° domain movement occurs and magnetization is produced without accompanying strain as in the 0 MPa and 4 MPa compressive stress levels in the monolithic material and 0 MPa in the composite materials.

For cases where sufficient compressive stress is applied to rotate the magnetization perpendicular to the field axis, we can model the strain-magnetization behavior quadratically. In this case Jiles showed that the magnetostriction can be modeled as λ=3/2λₛM²/Mₛ², where λₛ is the saturation magnetostriction from a fully random initial magnetization state (see, e.g. Jiles, D., Introduction to Magnetism and Magnetic Materials, Chapman and Hall, New York, 1991).

Using this model we can analyze the composite behavior and determine its dependence upon volume fraction. In this work, we argue that the saturation magnetostriction is relatively independent of the volume fraction of the particulate and heavily dependant on the orientation of the particles (FIG. 1). Using these assumptions and the previously stated argument that the magnetization of the composite is proportional to volume fraction, we can write for the composite magnetostriction,

$${λ}_{c} = \frac{3}{2} {{λ}_{s} ( \frac{M}{{v}_{p} {M}_{s}} )}^{2} \qquad ( B )$$

where λₛ is the saturation magnetostriction along the prescribed crystal axis from a demagnetized state and Mₛ is the saturation magnetization of monolithic Terfenol-D. Mechanically, this model represents an upper bound for the composite material behavior since we assume complete strain transfer from the particle to the matrix. This is equivalent to assuming that the particles behave as single fibers. Previous studies of the elastic modulus as a function of volume fraction in low volume fraction polymer matrix composites have indicated that this assumption is reasonable for magnetically aligned particulate composites (see, e.g. Duenas et al., Journal of Applied Physics, 87, pp. 4696-4701, 2000).

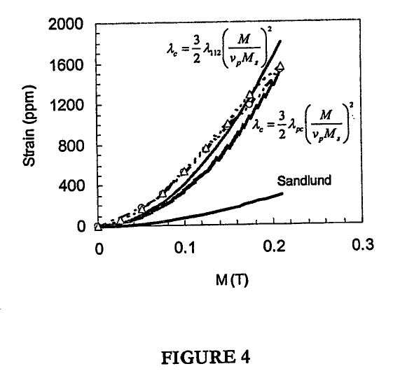

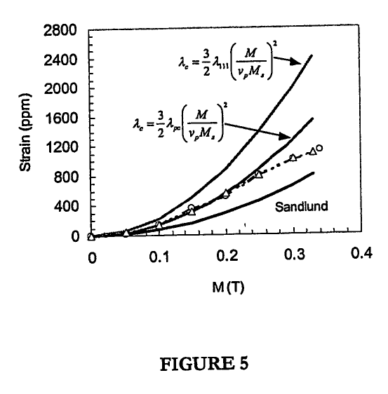

FIGS. 4 and 5 provide a comparison of parabolic magnetization models to experimental data (8 MPa and 12 MPa) for the OPC (FIG. 4) and NOPC (FIG. 5) assuming crystal alignment along the [112] axis for the OPC, [111] alignment for the NOPC, and for comparison assuming polycrystalline behavior. Sandlund's model with strain proportional to volume fraction has also been given. Experimental data nomenclature is identical to FIG. 3.

The results of this model are given in FIG. 4 along with experimental results for the OPC at 8 and 12 MPa compressive stresses. Models using both preferential orientation along the [112] direction and polycrystalline orientation are given for comparison. From the graph, we conclude that the model using λ₁₁₂ is the better model since the experimentally observed magnetostriction falls below this model. As described above, the model prediction of saturation magnetostriction must be an upper bound to the material behavior since it assumes an upper bound condition for mechanical strain transfer. Also included in FIG. 4 is the model taken from Sandlund et. al., where magnetostriction is proportional to particulate volume fraction.

In FIG. 5, we compare the model to the test data for the NOPC. The models are provided assuming both alignments along the easy [111] direction and polycrystalline behavior for the saturation magnetostriction λₛ. Again, the Sandlund model has been provided for comparison. From this figure, we observe that the polycrystalline orientation model provides the best fit to the data indicating that there is no preferential orientation associated with the ball-milled particles. For both the OPC and NOPC composites, the assumption that magnetostrictive strain is proportional to volume fraction is inadequate.

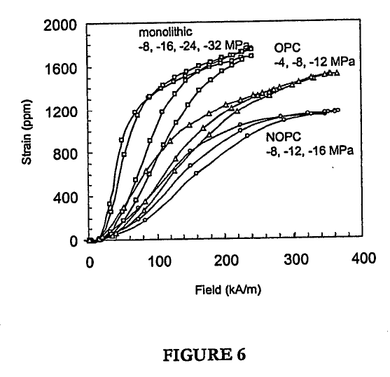

The average magnetostriction strain as a function of applied magnetic field for various applied constant loads is given in FIG. 6. From this figure, one can observe that the magnetostriction-field behavior of the OPC falls between that of the [112] oriented monolithic material and the NOPC material. The lower saturation strain in the OPC composite at all load levels may be accounted for by misalignment of the particles within the composite or by misalignment of the [112] direction in the particle itself. At comparable stress levels, the OPC material requires a much smaller field to produce an equivalent magnetostriction than the NOPC material. This may be partially attributed to improved particle orientation considering that the [112] direction requires much smaller fields to generate large magnetostriction than other crystal directions (see, e.g. Lim et al., Journal of Magnetism and Magnetic Materials, 191, pp. 113-121, 1999). One can also observe that both composite specimens require much higher applied fields to reach comparable strain levels as the monolithic. This agrees with previous results for magnetostrictive composites and is a combination of the demagnetization effects of finite length particles and the stress in the particulate as a result of combining a relatively high modulus particulate with a lower modulus matrix material to create a composite material. These effects provide information for studies of embodiments of these materials.

C. Analysis

As illustrated above, Terfenol-D particulate polymer matrix materials with [112] crystal orientation have been fabricated that achieve magnetostriction comparable to that of the monolithic material. The oriented composite exhibits a 30% increase in strain over the non-oriented composite, and also exhibits 85% of the saturation strain of commercially available Terfenol-D. The oriented particle composite is well described by a model utilizing the [112] saturation magnetostriction constant, λ₁₁₂ and the non-oriented particle composite is well described by utilizing a polycrystalline magnetostriction constant. These results indicate that the non-oriented composite exhibits polycrystalline behavior and does not show preferential alignment along the [111] axis as previously hypothesized.

### Illustrative Example 2

Skilled artisans will note a certain amount of overlap between the disclosure information that is provided in Example 1 and Example 2.

A. Protocols

As in Example 1 above, in this Example, two different types of composites (oriented and non-oriented) were manufactured for this study. The composites, along with a monolithic [112] Terfenol-D sample, were tested under combined magneto-mechanical loading at constant ambient temperature. Data recorded include load, strain, flux, and magnetic field. In the following paragraphs, the fabrication and testing approach is described in detail.

In this study, particle orientation along a specific crystal orientation was accomplished using particle shape anisotropy. Thus needle shaped particles with the longest axis along a direction of high magnetostriction were necessary. In Terfenol-D the maximum magnetostriction orientation is the [111]. However, commercially available material is only produced with the orientation axis primarily along the [112] direction. Therefore, particles were produced with [112] orientation using commercially available stock material. The stock material was milled along the rod axis using the dendritic microstructure to produce needle shaped Terfenol-D particles. These particles had aspect ratios of 2:1 or greater, and long axis dimensions close to the [112] direction. For improved high frequency response, the width of the needle should be decreased from these particles, but for this study the objective was to increase saturation strain and not specifically high frequency performance. The commercially available polydistributed ball-milled particles had roughly cubic dimensions less than 300 microns.

Composite specimens were prepared from both needle shaped particles and the commercially available ball milled particulate. For discussion purposes, the composite made with needle shaped particles will be referred to as the oriented particle composite (OPC), and the ball-milled particles as the non-oriented particle composite (NOPC). For each composite the particles were mixed with a vinyl ester thermosetting polymer and repeatedly degassed to eliminate voids. The composite slurry was then placed into an aluminum mold and a static magnetic field of approximately 100 kA/m was applied along the longitudinal direction of the composite using NdFeB magnets. This field aligns the particles into chain-like structures, which yields more favorable mechanical properties, and provides orientation of the needle shaped particles along their longest dimension. For the needle shaped particle composite, visual inspection was used to ensure successful orientation. For the purposes of this paper, particle alignment will refer to the formation of the particles into chain like structures, and particle orientation will refer to the crystallographic orientation of the particle within the composite.

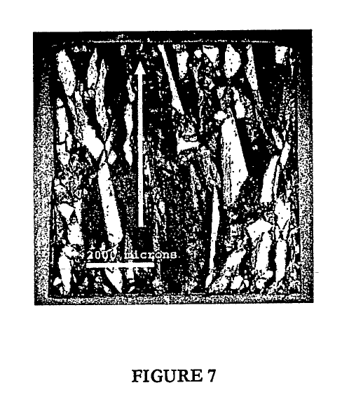

After curing at room temperature in the static field, the field was removed and both (OPC and NOPC) composites were post baked for 8 hours at 100° C. to ensure full cure of the polymer. The nominal dimensions of the rectangular OPC were 2.0×2.0×1.0 cm and the nominal dimensions of the cylindrical NOPC were 1.0 cm diameter by 2 cm length. All samples were instrumented for testing using foil strain gages and 20 turn search coils. The total gage area was ˜1 μm² which is on the order of the particles and thus some strain irregularities are expected. A photo of the OPC composite with needle shaped particles lying predominantly along the vertical orientation direction is given in FIG. 7.

B. Results

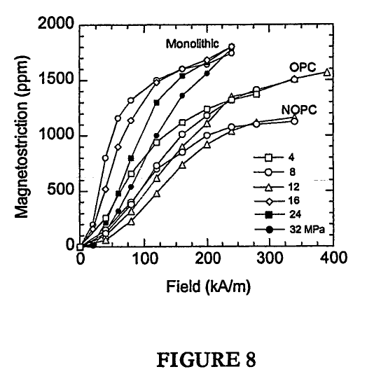

The results of average magnetostriction over a magnetization cycle for the oriented particle composite (OPC) and non-oriented particle composite (NOPC) as well as the monolithic material are given in FIG. 8. We note that the maximum magnetostriction measured for the OPC is 1570 ppm at 12 MPa compressive stress and 390 kA/m. The NOPC composite saturates at 1200 microstrain at 12 MPa compressive prestress and 350 kA/m. The monolithic had a peak strain of 1800 microstrain at 12 MPa compressive prestress and 240 kA/m. In addition for each material the application of higher stress levels results in increased field requirements to achieve a given magnetostriction. This effect is well understood and is the result of the perpendicular stress effectively increasing the anisotropy. This effective increase in anisotropy requires a larger field to rotate the magnetization away from the initial easy direction. In general the OPC requires less field to reach a given magnetostriction than the NOPC, but an increased field is necessary as compared to the monolithic. However, it is difficult to make any conclusions concerning the orientation of the particles from FIG. 8 because this behavior includes the effects of stress and demagnetizing fields which are different in the three materials considered.

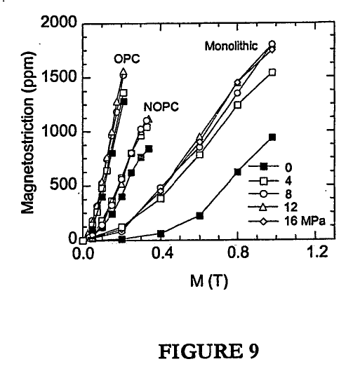

To isolate the effect of particle orientation on the performance of the composite, we examine the magnetization-strain behavior. The average strain over a full magnetization cycle as a function of magnetization is presented in FIG. 9. We note that the magnetization of the composite materials is significantly lower than the monolithic Terfenol-D, but the magnetostriction is comparable.

In addition, one observes that the composite saturation magnetization, Mₛ^{c}, is proportional to the volume fraction of particulate, vₚ, as in
Mₛ^{c}=vₚMₛ^{T-D} (1)
where Mₛ^{T-D} is the saturation magnetization of Terfenol-D (˜1.0 T).

The OPC had a particle volume fraction of 25% measured by weighting techniques, and the NOPC had a vₚ of 33%. Based on Eq. (1) the predicted Mₛ^{c} for the 25% and 33% composites is 0.25 T and 0.35 T, respectively, which agrees well with the measured results. The measured values of 0.22 T and 0.33 T have errors attributed to small measurement errors in both flux density and field. Vibrating sample magnetometer testing has confirmed that the actual saturation magnetization in the composite materials is proportional to volume fraction. As can be seen in FIG. 9, if stress is applied above a critical level such that all domains rotate into non-180° states, the magnetostriction strain as a function of magnetization is independent of stress. At stress levels below the critical level, some 180° domain movement occurs and net magnetization is produced without accompanying strain as in the 0 MPa and 4 MPa compressive stress in the monolithic material and 0 MPa in the composite materials.

Noting that FIGS. 8 and 9 are derived from the same test, we can clearly observe that the magnetization-strain behavior is useful to compare the magnetostriction of the composites. While the field-magnetostriction relationship is a strong function of applied stress (FIG. 8), there exists only one magnetization strain relationship. This phenomenon may be explained by observing that once sufficient stress is applied to rotate all domains perpendicular to the field direction, all magnetization results in magnetostriction. This statement is only absolutely true in the limit of a perfect single crystal, but is still valid in general for polycrystalline materials where sufficient stress has been applied to limit magnetization to rotation. In the following paragraphs, we will use this characteristic to compare the obtained composite magnetostriction to predicted values for composites as a function of orientation without the need to consider the effects of stress and demagnetization.

Therefore developed a model to predict the magnetostriction as a function of magnetization in composite materials given [111], [112], and polycrystalline particle orientation. Given that sufficient prestress has been applied to rotate the majority of domains perpendicular to the field direction we may assume that the magnetization takes place entirely through rotation. For this case, Jiles has shown that there exist a parabolic relationship between magnetostriction and magnetization (see, e.g. Jiles, D., 1991, Introduction to Magnetism and Magnetic Materials, Chapman and Hall, New York, p. 103). Along principal directions, the magnetostriction is proportional to 3/2λ, where λ is the magnetostriction from a demagnetized state. Therefore for a [111] oriented crystal we use 3/2λ₁₁₁=2400 microstrain. For a [11\overline{2}] oriented material with an initial magnetization along [111] and rotating to [11\overline{2}] at high fields, the expected single crystal magnetostriction would be 2023 microstrain (see, e.g. Teter et al., 1987, Journal of Applied Physics, 61 (8), pp. 3787-3789). This is calculated from the generalized relationship for a cubic material as a function of two magnetostriction constants (λ₁₀₀ and λ₁₁₁) and arbitrary magnetization and strain measurement directions. In a polycrystalline material, averaging techniques determine that the magnetostriction from a demagnetized state is λ_{pc}=2/5λ₁₀₀+3/5λ₁₁₁ and from a full rotation magnetostriction is 3/2λ_{pc}=1500. The basic form of the model from Jiles is

$$λ = {{λ}^{max} ( \frac{M}{{M}_{s}} )}^{2} , \qquad ( 2 )$$

where Mₛ is the saturation magnetostriction, and λₘₐₓ is the proportionality constant described above.

From Eq. (1) we have determined that the composite magnetization is proportional to volume fraction, and we may write the composite model as

$${λ}_{c} = \frac{3}{2} {{λ}^{max} ( \frac{M}{{v}_{p} {M}_{s}} )}^{2} \qquad ( 3 )$$

where vₚ is the volume fraction of particulate. As described above, we will use 1500, 2023, and 2400 ppm for

$${λ}_{p s}^{max} , {λ}_{112}^{max} , and {λ}_{111}^{max} ,$$

respectively.

Mechanically, this model represents an upper bound for the composite material behavior since we assume complete strain transfer from the particle to the matrix. This is equivalent to assuming that the particles behave as single fibers (i.e. 1-3 composite). Previous studies of the elastic modulus as a function of volume fraction have indicated that this assumption is reasonable for magnetically aligned particulate composites (see, e.g. Duenas et al., 2000, Journal of Applied Physics, 87, pp. 4696-4701).

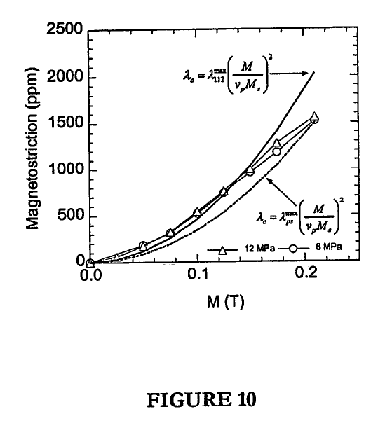

Using Eq. (2), analytical results are given in FIG. 10 along with experimental data for the OPC at 8 and 12 MPa compressive stresses. From the graph, we conclude that the model prediction proportional to

$${λ}_{112}^{max}$$

is the most appropriate since the experimentally observed magnetostriction falls below this model. As described above, the model prediction of saturation magnetostriction is an upper bound to the material behavior since it assumes constant strain (i.e. upper bound).

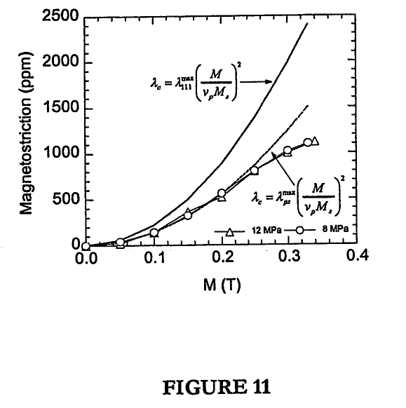

In FIG. 11, we compare the analytical predictions to the test data for the NOPC at 8 and 12 MPa compressive stress. Models results are provided assuming both alignments along the easy [111] direction (i.e. proportional to

$${λ}_{111}^{max} )$$

and polycrystalline behavior (i.e. proportional to

$${λ}_{p s}^{max} ) .$$

In FIG. 11, we conclude that the polycrystalline orientation model provides the best fit to the data This conclusion indicates that there is no preferential orientation along the [111] direction associated with the ball-milled particles. We conclude therefore, that the dominant force on the orientation of Terfenol-D particles during manufacture is the shape anisotropy. This counters previous hypotheses that magnetocrystalline anisotropy would provide preferential orientation along the [111] easy magnetic axes (see, e.g. Sandlund et al., 1994, Journal of Applied Physics, 75, pp. 5656-5658). Furthermore, for particles with shape anisotropy along a known crystallographic axis, this property may be used to produce composites with particle orientation along a predetermined crystal direction.

For highly anisotropic magnetostrictive materials such as Terfenol-D, this development is crucial to creating composite materials with magnetostriction performance matching as closely as possible the monolithic material.

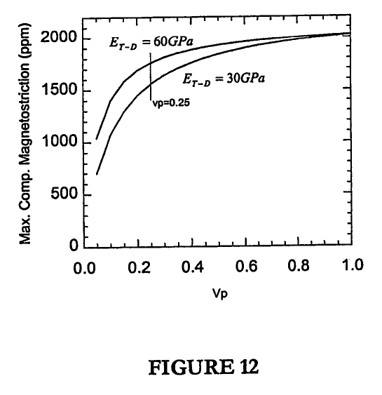

Finally, we use a simple rule of mixtures formulation to predict the upper bound magnetostriction in the composite material. The rule of mixtures theory predicts a mutual stress will be created in the composite when constituent materials of different moduli strain with respect to each other. This mutual stress leads to a compressive stress in the particulate which decreases the total possible strain (i.e. magnetostriction) in the composite. Following the 1-3 formulation for composite, we obtain the maximum strain expected in the composite material as a function of vₚ,

$${λ}_{c}^{max} = \frac{{λ}^{tot} {E}_{p} {v}_{p}}{{E}_{p} {v}_{p} + ( 1 - {v}_{p} ) {E}_{m}} \qquad ( 4 )$$

where λ_{c}^{max} is the maximum possible strain in the composite, λ^{tot} is the total magnetostriction from the magnetostrictive particulate, and Eₚ and Eₘ are the modulus of elasticity of the particulate and matrix, respectively. FIG. 12 gives the maximum possible magnetostriction in the composite material for a λ^{tot}=2023 ppm, Eₘ=3 GPa, and Eₚ=30 and 60 GPa. Two moduli have been given for Terfenol-D because it is highly variable and dependent on the stress and field conditions. From FIG. 12, we observe that for the two moduli given and a vₚ=0.25 the range of expected maximum magnetostriction of the composite is between 1556 and 1760 ppm. Thus for this volume fraction most (89-100%) of the theoretically predicted magnetostriction was observed in the composite. We may also conclude from FIG. 12 that one possible method to further increase saturation strain in composite materials is to decrease the matrix content and decrease the modulus of the matrix.
   C. Analysis

As illustrated above, a particulate magnetostrictive composite material has been fabricated with a desired crystal orientation using shape anisotropy. The resultant composite material exhibits a saturation strain in excess of 1550 ppm at 12 MPa compressive load as compared to 1200 ppm at 12 MPa compressive load for a similar non-oriented composite. Examining the magnetostriction behavior as a function of magnetization further supported this finding. A simple quadratic model indicated that the oriented particle was most satisfactorily described by [112] behavior and the non-oriented composite by polycrystalline behavior.

Throughout this application, various publications are referenced. The disclosures of these publications are hereby incorporated by reference herein in their entireties. The present invention is not to be limited in scope by the embodiments disclosed herein, which are intended as single illustrations of individual aspects of the invention, and any that are functionally equivalent are within the scope of the invention. Various modifications to the models and methods of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

1. A method of forming a composite comprising a matrix material and a plurality of particles oriented along a specific crystal axis, the method comprising:
(a) combining the matrix material with the particles, wherein the particles of the composite are selected to be ferromagnetic and to have an aspect ratio sufficient to align them along their longest dimension in the presence of a magnetic field;
(b) exposing the particles within the matrix material to a magnetic field sufficient to align them in a crystallographic orientation;
(c) allowing the composite to form such that the particles exhibit a crystallographic orientation within the matrix material of the composite.

2. A composite produced by the method of claim 1.

3. The method of claim 1, wherein the particles are comprised of a first non-ferromagnetic composition coated with a ferromagnetic material.

4. The method of claim 1, wherein the particles are comprised of Terfenol-D.

5. The method of claim 1, wherein the matrix comprises a polymeric material.

6. The method of claim 5, wherein the polymeric material comprises a vinyl ester.

7. The method of claim 1, wherein the composite is formed to exhibit at least about a 10% increase in saturation magnetostriction over a control composite having non-oriented particles.

8. The method of claim 1, wherein the composite is formed to exhibit a saturation magnetostriction that is at least about 70% of the saturation magnetostriction exhibited by a comparable monolithic material.

9. The method of claim 1, wherein the composite is formed to exhibit at least about a 1 order of magnitude decrease in electrical resistance as compared to a comparable monolithic material.

10. A composition comprising a matrix material combined with a plurality of particles, wherein the particles are ferromagnetic and have an aspect ratio sufficient to align them along their longest dimension in the presence of a magnetic field and further wherein the particles exhibit a crystallographic orientation within the matrix material.

11. A method of forming a composite comprising a matrix material and a plurality of particles oriented along a specific crystal axis, the method comprising:
(a) combining the matrix material with the particles, wherein the particles of the composite are selected to be ferromagnetic and to have a magnetocrystalline anisotropy sufficient to overcome their shape anisotropy in the presence of a magnetic field;
(b) exposing the particles within the matrix material to a magnetic field sufficient to align them in a crystallographic orientation;
(c) allowing the composite to form such that the particles exhibit a crystallographic orientation within the matrix material of the composite.

12. A composite produced by the method of claim 11.

13. The method of claim 11, wherein the particles of the composite are selected to have a magnetocrystalline anisotropy sufficient to overcome their shape anisotropy in the presence of a magnetic field by geometrical criteria.

14. The method of claim 13, wherein the particles are selected to be spheroid.

15. The method of claim 11, wherein the particles of the composite are selected to have a magnetocrystalline anisotropy sufficient to overcome their shape anisotropy in the presence of a magnetic field by compositional criteria.

16. The method of claim 11, wherein the composite is formed to exhibit at least about a 10% increase in saturation magnetostriction over a control composite having non-oriented particles.

17. The method of claim 11, wherein the composite is formed to exhibit a saturation magnetostriction that is at least about 70% of the saturation magnetostriction exhibited by a comparable monolithic material.

18. The method of claim 11, wherein the composite is formed to exhibit at least about a 1 order of magnitude decrease in electrical resistance as compared to a comparable monolithic material.

19. A composition comprising a matrix material combined with a plurality of particles, wherein the particles are ferromagnetic have a magnetocrystalline anisotropy sufficient to overcome their shape anisotropy in the presence of a magnetic field and further wherein the particles exhibit a crystallographic orientation within the matrix material.

20. A method of forming a composite comprising a matrix material and a plurality of particles oriented along a specific crystal axis, the method comprising:
(a) combining the matrix material with the particles, wherein the particles are selected to exhibit properties that allow them to organize into a crystallographic orientation in the presence of a magnetic, electric or mechanical field;
(b) exposing the particles within the matrix material to a magnetic, electric or mechanical field sufficient to align them in a crystallographic orientation;
(c) allowing the composite to form such that the particles exhibit a crystallographic orientation within the matrix material of the composite.

21. The method of claim 20, wherein the particles are selected to exhibit ferromagnetic properties that allow them to organize into a crystallographic orientation in the presence of a magnetic field.

22. The method of claim 20, wherein the particles are selected to exhibit ferroelectric properties that allow them to organize into a crystallographic orientation in the presence of an electric field.

23. The method of claim 20, wherein the particles are selected to exhibit ferroelastic properties that allow them to organize into a crystallographic orientation in the presence of a mechanical field.

24. The method of claim 20, wherein the composite is formed to exhibit at least about a 10% increase in saturation actuation/sensing strain over a control composite having non-oriented particles or at least about 70% of the saturation actuation/sensing strain exhibited by a comparable monolithic material.

25. A composite formed by the method of claim 20.
